(19) United States
(12) Patent Application Publication
(10) Pub. No.: US 2011/0149042 A1
(43) Pub. Date: Jun. 23, 2011

(54) METHOD AND APPARATUS FOR GENERATING A STEREOSCOPIC IMAGE

(75) Inventors: Chung-Hwan LEE, Daejeon (KR); Seung-Woo Nam, Daejeon (KR)

(73) Assignee: Electronics and Telecommunications Research Institute, Daejeon (KR)

(21) Appl. No.: 12/968,742

(22) Filed: Dec. 15, 2010

(30) Foreign Application Priority Data
Dec. 18, 2009 (KR) 10-2009-0126718
Apr. 1, 2010 (KR) 10-2010-0029957

(51) Int. Cl. H04N 13/02

(52) U.S. Cl. 348/46; 348/E13.074

(57) ABSTRACT

Provided is a method for generating stereoscopic image fedback by the interaction with a real world. Even though the method according to the related art interacts the user with the virtual object or forms the stereoscopic image without interacting with the object in the user space by controlling the virtual object using a separate apparatus, the present invention feedbacks the interaction between all the object in the user space including the object and users in the virtual space to the video reproducing system to implement a system for re-processing and reproducing the stereoscopic image, thereby making it possible to produce realistic stereoscopic image.

### CROSS REFERENCE TO RELATED APPLICATIONS

This application claims priority to Korean Patent Application No. 10-2009-0126718 filed on Dec. 18, 2009 and Korean Patent Application No. 10-2010-0029957 filed on Apr. 1, 2010, the entire contents of which are herein incorporated by reference.

### BACKGROUND OF THE INVENTION

1. Field of the Invention

The present invention relates to a method and an apparatus for generating a stereoscopic image, and more particularly, to a method and an apparatus for generating a stereoscopic image suitable to represent interaction between object in a virtual world and object in real world.

2. Description of the Related Art

With the recent improvement of computer performance, a three-dimensional computer graphics (CG) technology has been widely used for movies, advertisement, game, animation, and so on. In particular, with the development of the graphics technology, videos having the same or approximately similar level as realistic photographed videos can be generated. As a result, a need exists for a hyperrealistic video expression technology.

In particular, unlike a 3D video projected on the existing 2D display, the stereoscopic image provides a depth of only the stereoscopic image, thereby making it possible to produce more realistic videos. Although a method of realistically reproducing videos that is seen as if the stereoscopic image is in a space, that is, a 3D video, is attempted, the most widely studied method provides the same videos as ones seen from each left and right directions and synthesizes them by using the time difference between two eyes, such that the videos seem like one stereoscopic image. As a method for separating videos in left and right directions and seeing the videos through left and right eyes, polarizing glasses, color filter glasses, or a screen, etc., are used. Meanwhile, the method for generating stereoscopic image according to the related art is disclosed in “J. Baker, “Generating Images for a Time-Multiplexed Stereoscopic Computer Graphics System,” in True 3D Imaging Techniques and Display Technologies, Proc. SPIE, vol. 761, pp. 44-52, 1987”.

However, the method for generating stereoscopic image according to the related art has a limitation in that the stereoscopic image generated at the time of producing the stereoscopic image should be simply played-back or the virtual object existing in the 3D video should be operated by using a separate apparatus in order to achieve the interaction between the virtual object in the videos.

### SUMMARY OF THE INVENTION

The present invention has been made in an effort to provide an apparatus and a method for generating stereoscopic image by recognizing a feedback space in which a real space can interact with a video space and real object in the feedback space and calculating interactions with virtual object.

An exemplary embodiment of the present invention provides a method for generating stereoscopic image, including: calculating a feedback space by using stereoscopic image space information on a display video and user view space information on a user space; recognizing real object and virtual object in the feedback space and extracting space information on the recognized real object and virtual object; determining whether interaction is enabled by using the space information on the real object and the virtual object and analyzing the interaction according to the determination result; and generating new stereoscopic image according to the result of the analyzed interaction.

The determining whether the interaction is enabled may be performed by comparing distances between the predetermined interaction enabling spaces in the feedback space and the real object in the feedback space.

The analyzing the interaction may includes: measuring the distance between the real object in the interaction enabling space and the feedback space; and generating the interaction information when the distance between the interaction enabling space and the real object interacts.

The interaction information may includes the interaction direction and the space information between the real object and the virtual object, and the analyzing the interaction may further includes searching an interaction scenario for the virtual object based on the interaction information.

After the searching the interaction scenario, the analyzing the interaction may further includes analyzing the interaction of contact and collision by using the interaction direction or the space information of the interaction information.

The searching the interaction scenario may further includes storing the interaction scenario video according to the virtual object, the interaction direction, and the space information when there is the interaction scenario.

The interaction information may includes the interaction direction and the space information between the real object and the virtual object, and the analyzing the interaction may further includes searching simulation for the interaction between the virtual object based on the interaction information.

The method for generating stereoscopic image may further includes after searching the simulation for the interaction, analyzing the interaction of contact and collision by using the interaction direction or the space information of the interaction information.

There is the simulation for the interaction between the virtual object, the searching the simulation for the interaction may further includes performing the simulation according to the virtual object, the interaction direction, and the space information.

The generating the stereoscopic image may generates the stereoscopic image by using the interaction result between the virtual object and the real object, when there is the interaction scenario, generates new stereoscopic image by synthesizing the interaction scenario with the virtual object, and when there is the simulation, generates the new stereoscopic image by configuring the simulation for the virtual object.

Another exemplary embodiment of the present invention provides an apparatus for generating stereoscopic image, including: a space recognizing unit that calculates a feedback space by using stereoscopic image space information on a display video and user view space information on a user space; an object recognizing unit that recognizes real object and virtual object in the feedback space and extracts space information on the recognized real object and virtual object; an interacting analyzing unit that determines whether the interaction is enabled by using the space information on the real object and the virtual object and analyzes the interaction according to the determination result; and an image generator that generates new stereoscopic image according to the result of the analyzed interaction.

According to the exemplary embodiment of the present invention, it effectively represents the interaction between the real object and the virtual object in the feedback space to generate a realistic stereoscopic image.

### BRIEF DESCRIPTION OF THE DRAWINGS

FIG. 1 is a diagram referenced for explaining a method for generating a stereoscopic image that is fedback by interaction with user space object according to an exemplary embodiment of the present invention;

FIG. 2 is diagram showing a configuration of an apparatus of generating stereoscopic image according to an exemplary embodiment of the present invention; and

FIG. 3 is a flow chart showing a method for generating stereoscopic image according to an exemplary embodiment of the present invention.

### DETAILED DESCRIPTION OF THE PREFERRED EMBODIMENTS

Hereinafter, exemplary embodiments of the present invention will be described in detail with reference to the accompanying drawings. The following description and the accompanying drawings are provided in order to help the overall understanding of the present invention and the detailed description of the known functions and components will be omitted so as not to obscure the description of the present invention with unnecessary detail.

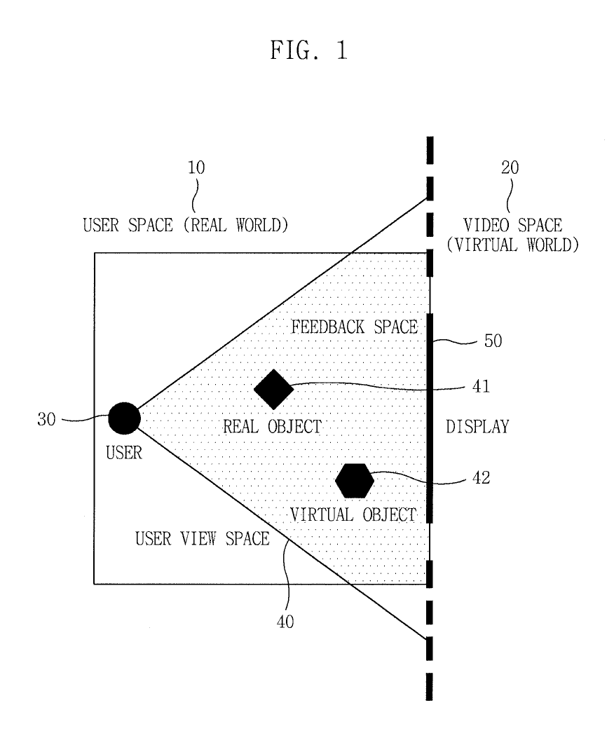

FIG. 1 is a diagram referenced for explaining a method for generating a stereoscopic image that is fedback by interaction with user space object according to an exemplary embodiment of the present invention.

Referring to FIG. 1, a method for generating stereoscopic image according to an exemplary embodiment of the present invention is configured to include calculating a feedback space 50 by using information of video space 20 (virtual world) regarding a display video and user view space information regarding a user space 10 (real world), recognizing real object (or virtual object) in a feedback space and extracting space information of each object, analyzing interaction by using the space information of an real object 41 and a virtual object 42, and generating stereoscopic image according to the result of the interaction.

In the present invention, the display video means a video displayed on a display. The information of the video space 20 (virtual world) means information included in the display video displayed by the display, for example, depth, size, texture, and so on.

In addition, the user space 10 (real world) means the user space in contrast with the video space 20. The user view space information means the space in a visible range of the user 30 among the user spaces 10.

Next, a feedback space 50 means a space in which the video space 20 and the user space 10 interacts. In this case, the objects in the feedback space include real object 41 and virtual object 42.

Described in more detail, the method for generating the stereoscopic image according to an exemplary embodiment of the present invention displays the stereo image information photographed by a 3D method through a display screen. In this case, the stereoscopic image information includes space information on the stereoscopic image. The user recognizes the stereoscopic image seen through a display in his/her own view space.

The method for generating the stereoscopic image according to an exemplary embodiment of the present invention generates the feedback space by using the space information and the user view information in the video space. In other words, the method for generating the stereoscopic image according to an exemplary embodiment of the present invention recognizes the feedback space by comparing the space information and the user view information in the video space. For example, the method recognizes the range of the user view space formed between the user and the display based on the position of the user and generates, as the feedback space, the space overlapping with the space information formed as the video space.

The method for generating the stereoscopic image according to an exemplary embodiment of the present invention searches each object in the feedback space by using data for the generated feedback space and updates the space information of the searched object. In other words, the method for generating the stereoscopic image according to an exemplary embodiment of the present invention acquires the information on the real object existing in the feedback space, for example, position, volume, size, texture, and so on, by a sensor, a camera, and so on. The information on the virtual object displayed by the stereoscopic image is updated with the information on the real object.

The method for generating the stereoscopic image according to an exemplary embodiment of the present invention analyzes the interaction between the video object and the real object and calculates the effect of the interaction. In other words, the method for generating the stereoscopic image according to an exemplary embodiment of the present invention analyzes contact and operation situations between the video object and the real object and calculates the operational effect accordingly.

Next, the method for generating the stereoscopic image according to an exemplary embodiment of the present invention is rendered based on the analyzed interaction effect, thereby generating the stereoscopic image. For example, the method for generating the stereoscopic image according to an exemplary embodiment of the present invention generates the effect generated according to the contact between the real object and the virtual object, etc., as the stereoscopic image.

Unlike the related art, the method for generating the stereoscopic image according to an exemplary embodiment of the present invention generates the stereoscopic image representing the interaction through a series of processes.

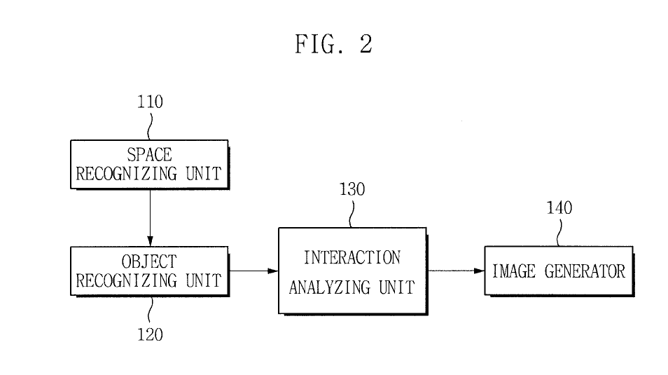

FIG. 2 is diagram showing a configuration of an apparatus of generating stereoscopic image according to an exemplary embodiment of the present invention.

Referring to FIG. 2, an apparatus for generating stereoscopic image to which the method for generating the stereoscopic image according to an exemplary embodiment of the present invention is configured to include a space recognizing unit 110, an object recognizing unit 120, an interaction analyzing unit 130, and an image generator 140.

The space recognizing unit 110 receives 3D information including depth information input to image data at the time of producing videos, that is, the stereoscopic image information through the pre-stored data base. The space recognizing unit 110 uses the information recognized by the camera and the plurality of sensors installed in the user space to receive the space information of the user space and the viewing information of the user. The space recognizing unit 110 generates the user view space information through the space information of the user space and the viewing information of the user. The space recognizing unit 110 uses the stereo space information and the user view space information to calculate the feedback space that is an intersection between the information on the video space 20 and the user space. For example, the space recognizing unit 110 calculates the space that is an intersection between the information on the video space information and the real space and determines it as the feedback space.

The object recognizing unit 120 searches object in the user space and the feedback space provided by the above-mentioned camera and sensor to generate and update the space information of each object. Each searched object is updated to the 3D objection information having the space information including the depth from the display device.

The interaction analyzing unit 130 analyzes data generated from the object recognizing unit 120 to analyze the interaction between the real object and the virtual object in the feedback space. The interaction analyzing unit 130 measures the distance between the interaction enabling space of each virtual object existing in the feedback space and the real object in the feedback space. The interaction analyzing unit 130 uses the measured result to determine whether the distance between respective object can interact.

Further, the interaction analyzing unit 130 determines the direction and the space information of the interaction between the real object and the virtual object in the state where the interaction between respective object are enabled according to the result of determination. The interaction analyzing unit 130 searches the interaction scenario of the given virtual object and analyzes the interaction between the real object and the virtual object.

In this case, the interaction analyzing unit 130 transmits the ID and updated space information of the interaction scenario image according to the virtual object, the interaction direction, and the space information to an image generator 140 to be described below when there is the interaction scenario video for the corresponding virtual object.

Further, the interaction analyzing unit 130 performs simulation according to the virtual object, the interaction direction and transfers the simulated results to the image generator 140 when there is simulation for the interaction between the corresponding virtual object.

The image generator 140 generates the stereoscopic image by using the interaction result between the virtual object and the real object transferred from the above-mentioned interaction analyzing unit 130.

The image generator 140 synthesizes the given scenario videos with the object being subjected to the interaction between the corresponding stereoscopic image when there is the scenario video.

Further, the image generator 140 renders the data generated according to the result of the simulation to generate and synthesize the videos.

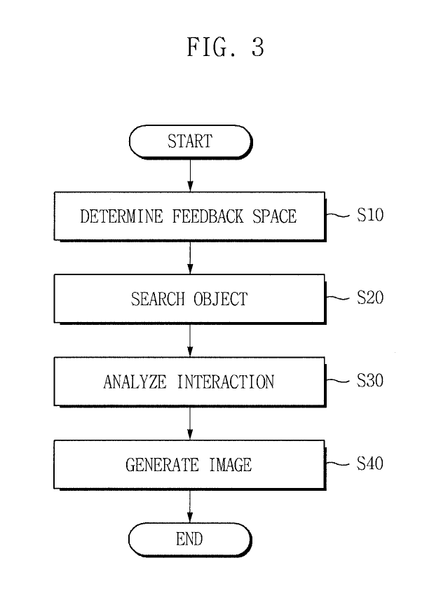

FIG. 3 is a flow chart showing a method for generating stereoscopic image according to an exemplary embodiment of the present invention.

Referring to FIG. 3, one example of a method for generating stereoscopic image according to an exemplary embodiment of the present invention will be described. In the description, the same reference numerals shown in FIGS. 1 and 2 perform the same function.

First, the space recognizing unit 110 calculates and determines the feedback space by using the space information of the stereoscopic image on the display video and the user view space information on the user space (S10). In other words, the space recognizing unit 110 uses the information recognized by the camera and the plurality of sensors installed in the user space to receive the space information of the user space and the viewing information of the user and calculate the user view space information based thereon. The space recognizing unit 110 uses the predetermined stereo space information and the user view space information to determine the feedback space that is an intersection between the video space information and the user view space (see reference number 40 of FIG. 1).

Next, the object recognizing unit 120 searches the object in the given user space and feedback space by using the above-mentioned camera and sensor (S20). The object recognizing unit 120 generates the space information on each searched object and generates the update (see reference numerals 41 and 42 of FIG. 1).

Then, the interaction analyzing unit 130 analyzes data generated from the space recognizing unit 110 to analyze the interaction between the real object and the virtual object in the feedback space (S30).

The interaction analysis will be described in more detail.

First, the interaction analyzing unit 130 measures the distance between the interaction enabling space of each virtual object existing in the feedback space and the real object in the feedback space. The interaction analyzing unit 130 uses the measured result to determine whether the distance between respective object can interact.

In this case, the interaction analyzing unit 130 determines the direction and the space information of the interaction between the real object and the virtual object in the state where the interaction between respective object are enabled according to the result of determination. The interaction analyzing unit 130 searches the interaction scenario of the given virtual object and analyzes the interaction between the real object and the virtual object.

In this case, the interaction analyzing unit 130 transmits the ID and updated space information of the interaction scenario image according to the virtual object, the interaction direction, and the space information to an image generator 140 to be described below when there is the interaction scenario video for the corresponding virtual object. For example, there is no distance difference between the real object 41 and the virtual object 42 shown in FIG. 1 and when the region in which the virtual object is positioned is the interaction region, it is determined as the collision or the contact state between two object. In this case, the scenario video for the virtual object is searched. In this case, the scenario video may be the scenario video such as video where the virtual object 42 colliding with the real object 41 is changed to another shape, etc.

Further, the interaction analyzing unit 130 performs the simulation according to the virtual object, the interaction direction and transfers the simulated results to the image generator 140 when there is the simulation for interaction between the corresponding virtual object. For example, there is no distance difference between the real object 41 and the virtual object 42 shown in FIG. 1 and when the region in which the virtual object is positioned is the interaction region, it is determined as the collision or the contact state between two object. In this case, the simulation for the virtual object is searched. In this case, the simulation may be video where the virtual object 42 colliding with the real object 41 is pushed or damaged.

The image generator 140 generates the stereoscopic image by using the interaction result between the virtual object and the real object transferred from the above-mentioned interaction analyzing unit 130 (S40).

The image generator 140 synthesizes the given scenario videos with the object being subjected to the interaction between the corresponding stereoscopic image when there is the scenario video. For example, when the scenario video is a scenario video such as video where the virtual object 42 colliding with the real object 41 is changed to another shape, etc., the corresponding scenario video is synthesized with the existing stereoscopic image. Therefore, the user can see the interaction between the real object and the virtual object.

Further, the image generator 140 renders the data generated according to the result of the simulation to generate and synthesize the videos. In this case, the simulation for the virtual object is searched. In this case, when the simulation is a video where the virtual object 42 colliding with the real object 41 is pushed or damaged, the corresponding simulation video is synthesized with the existing stereoscopic image.

As described above, the present invention effectively represents the interaction between the real object and the virtual object in the feedback space, thereby making it possible to generate the realistic stereoscopic image. Therefore, the real feeling of the stereoscopic image can be increased and the useable range of the stereoscopic image can be expanded.

As described above, although the method for generating the feedback stereoscopic image by the interaction with the user space object according to an exemplary embodiment of the present invention is described with reference to the illustrated drawings, the present invention is not limited to the embodiment disclosed in the specification and the drawings but can be applied within the technical scope of the present invention.

What is claimed is:

1. A method for generating stereoscopic image, comprising:
calculating a feedback space by using stereoscopic image space information on a display video and user view space information on a user space:
recognizing real object and virtual object in the feedback space and extracting space information on the recognized real object and virtual object;
determining whether interaction is enabled by using the space information on the real object and the virtual object and analyzing the interaction according to the determination result; and
generating new stereoscopic image according to the result of the analyzed interaction.

2. The method for generating stereoscopic image according to claim 1, wherein the determining whether the interaction is enabled is performed by comparing distances between the predetermined interaction enabling spaces in the feedback space and the real object in the feedback space.

3. The method for generating stereoscopic image according to claim 2, wherein the analyzing the interaction includes:
measuring the distance between the real object in the interaction enabling space and the feedback space; and
generating the interaction information when the distance between the interaction enabling space and the real object interacts.

4. The method for generating stereoscopic image according to claim 3, wherein the interaction information includes the interaction direction and the space information between the real object and the virtual object, and
the analyzing the interaction further includes searching an interaction scenario for the virtual object based on the interaction information.

5. The method for generating stereoscopic image according to claim 4, further comprising after the searching the interaction scenario, analyzing the interaction of contact and collision by using the interaction direction or the space information of the interaction information.

6. The method for generating stereoscopic image according to claim 5, wherein the searching the interaction scenario further includes storing the interaction scenario video according to the virtual object, the interaction direction, and the space information when there is the interaction scenario.

7. The method for generating stereoscopic image according to claim 4, wherein the interaction information includes the interaction direction and the space information between the real object and the virtual object, and the analyzing the interaction further includes searching simulation for the interaction between the virtual object based on the interaction information.

8. The method for generating stereoscopic image according to claim 7, further comprising after searching the simulation for the interaction, analyzing the interaction of contact and collision by using the interaction direction or the space information of the interaction information.

9. The method for generating stereoscopic image according to claim 8, wherein when there is the simulation for the interaction between the virtual object, the searching the simulation for the interaction further includes performing the simulation according to the virtual object, the interaction direction, and the space information.

10. The method for generating stereoscopic image according to claim 1, wherein the generating the stereoscopic image includes:
generating the new stereoscopic image by using an interaction result between the virtual object and the real object by synthesizing an interaction scenario with the virtual object when there is the interaction scenario; and
generating the new stereoscopic image by using an interaction result between the virtual object and the real object by configuring simulation for the virtual object when there is the the simulation.

11. An apparatus for generating stereoscopic image, comprising:
a space recognizing unit that calculates a feedback space by using stereoscopic image space information on a display video and user view space information on a user space;
an object recognizing unit that recognizes real object and virtual object in the feedback space and extracts space information on the recognized real object and virtual object;
an interacting analyzing unit that determines whether interaction is enabled by using the space information on the real object and the virtual object and analyzes the interaction according to the determination result; and
an image generator that generates new stereoscopic image according to the result of the analyzed interaction.

12. The apparatus for generating stereoscopic image according to claim 11, wherein the interaction analyzing unit determines whether the interaction is enabled by comparing a distance between the predetermined interaction enabling space in the feedback space and the real object in the feedback space.

13. The apparatus for generating stereoscopic image according to claim 12, wherein the interaction analyzing unit measures the distance between the real object in the interaction enabling space and the feedback space; and generates the interaction information when the distance between the interaction enabling space and the real object interacts.

14. The apparatus for generating stereoscopic image according to claim 13, wherein the interaction information includes the interaction direction and the space information between the real object and the virtual object, and the interaction analyzing unit searches an interaction scenario for the virtual object based on the interaction information.

15. The apparatus for generating stereoscopic image according to claim 14, wherein the interaction analyzing unit analyzes the interaction of contact and collision by using the interaction direction or the space information of the interaction information.

16. The apparatus for generating stereoscopic image according to claim 15, wherein the interaction analyzing unit stores the interaction scenario video according to the virtual object, the interaction direction, and the space information when there is the interaction scenario.

17. The apparatus for generating stereoscopic image according to claim 14, wherein the interaction information includes the interaction direction and the space information between the real object and the virtual object, and the interaction analyzing unit searches simulation for the interaction between the virtual object based on the interaction information.

18. The apparatus for generating stereoscopic image according to claim 17, wherein the interaction analyzing unit performs the simulation according to the virtual object, the interaction direction, and the space information when there is the simulation for the interaction between the virtual object.

19. The apparatus for generating stereoscopic image according to claim 11, wherein the image generator generates the new stereoscopic image by using the interaction result between the virtual object and the real object by synthesizing an interaction scenario with the virtual object when there is the interaction scenario, and the image generator generates the new stereoscopic image by using an interaction result between the virtual object and the real object by configuring the simulation for the virtual object when there is the simulation.
